(19) United States
(12) Patent Application Publication
(10) Pub. No.: US 2012/0268541 A1
(43) Pub. Date: Oct. 25, 2012

(54) INK JET RECORDING APPARATUS AND INK JET RECORDING METHOD

(75) Inventors: Ayako NISHIKI, Matsumoto (JP); Soichi YAMAZAKI, Shiojiri (JP)

(73) Assignee: SEIKO EPSON CORPORATION, Tokyo (JP)

(21) Appl. No.: 13/450,917

(22) Filed: Apr. 19, 2012

(30) Foreign Application Priority Data
Apr. 22, 2011 (JP) 2011-095865

(51) Int. Cl. B41J 29/38

(52) U.S. Cl. 347/104

(57) ABSTRACT

An ink jet recording apparatus in which an image is recorded by ejecting a pigment ink from an ink jet head on a recording surface of a recording medium, the apparatus including: a recording medium transporting unit which transports the recording medium, and a recording medium discharging unit which discharges the recording medium, wherein the recording medium discharging unit includes a discharging roller installed on the opposite side to the recording surface of the recording medium and a cylinder-shaped driven roller installed on the recording surface side of the recording medium so as to face the discharging roller, the driven roller has an electrical resistivity smaller than 108 Ωcm, and is grounded, and the pigment ink has an electrical conductivity of equal to or more than 0.5 mS/m.

The entire disclosure of Japanese Application No. 2011-095865 filed on Apr. 22, 2011 is expressly incorporated by reference herein.

### BACKGROUND

1. Technical Field

The present invention relates to an ink jet recording apparatus and an ink jet recording method.

2. Related Art

In the related art, an ink jet recording apparatus in which an image is recorded by an ink ejected from an ink jet head on a recording medium such as paper has been known.

This type of ink jet apparatus, in general, includes a recording medium transporting unit which transports the recording medium to the ink jet head, and a recording medium discharging unit which discharges the recording medium on which the image is recorded out of the apparatus. The recording medium discharging unit usually includes a discharging roller (driving roller) at the opposite side of the recording surface of the recording medium and a driven roller on the recording surface side.

While a driven roller in cylindrical shape is common in the related art, there has been an issue that wet ink has attached to the driven roller due to a frictional electrification between the recording medium and the driven roller. By the rotation of the driven roller, the ink which has attached to the driven roller attaches to the region on the medium where the ink is not supposed to attach, and the quality of the image formed deteriorates.

In order to solve such an issue, attempts are made to use a spur as the driven roller so that the contact area between the recording medium and the driven roller is reduced (refer to JP-A-2-41277, for example).

However, with a recent trend toward further improvement of the image recording speed, with the spur of the related art, it is difficult to deliver the driving force of the discharging roller to the recording medium and to improve the image recording speed due to the small contact area with the recording medium.

### SUMMARY

An advantage of some aspects of the invention is to provide an ink jet recording apparatus and an ink jet recording method that are capable of recording a high quality image at high speed.

Some aspects of the invention to achieve this advantage are as follows.

According to an aspect of the invention, there is provided an ink jet recording apparatus in which an image is recorded by ejecting a pigment ink from an ink jet head on a recording surface of a recording medium, the apparatus includes a recording medium transporting unit which transports the recording medium, and a recording medium discharging unit which discharges the recording medium, wherein the recording medium discharging unit includes a discharging roller installed on the opposite side to the recording surface of the recording medium and a cylinder-shaped driven roller installed on the recording surface side of the recording medium so as to face the discharging roller, the driven roller has an electrical resistivity smaller than 10⁸ Ωcm, and is grounded, and the pigment ink has an electrical conductivity of equal to or more than 0.5 mS/m.

Therefore, it is possible to provide an ink jet recording apparatus that is capable of recording a high quality image at high speed.

In the ink jet recording apparatus according to an aspect of the invention, it is preferable that the driven roller be formed of a material that contains a conductive urethane resin.

This may prevent the pigment ink on the recording medium from attaching to the driven roller more effectively; therefore, an image with higher quality may be recorded.

The ink jet recording apparatus according to an aspect of the invention, it is preferable that the pigment ink contain a wax.

This may prevent the pigment ink on the recording medium from attaching to the driven roller more effectively.

In the ink jet recording apparatus according to an aspect of the invention, it is preferable that the wax contain a crystalline ethylene based polymer.

This may prevent the pigment ink on the recording medium from attaching to the driven roller more effectively, therefore, an image with higher quality may be recorded.

In the ink jet recording apparatus according to an aspect of the invention, it is preferable that the pigment ink contain an ionic substance.

This may prevent the pigment ink on the recording medium from attaching to the driven roller more effectively; therefore, an image with higher quality may be recorded.

According to another aspect of the invention, there is provided an ink jet recording method in which an image is recorded by ejecting a pigment ink from an ink jet head on a recording surface of a recording medium, the method includes preparing an ink jet recording apparatus including a recording medium transporting unit which transports the recording medium to the ink jet head and a recording medium discharging unit which discharges the recording medium on which the image is recorded by the ink jet head, preparing, in the recording medium discharging unit, a discharging roller which is installed on the opposite side to the recording surface of the recording medium and a cylinder-shaped driven roller which is installed on the recording surface side of the recording medium so as to face the discharging roller, wherein the driven roller has an electrical resistivity smaller than 10⁸ Ωcm, and is grounded, and the pigment ink has an electrical conductivity of equal to or more than 0.5 mS/m.

Therefore, it is possible to provide an ink jet recording method that is capable of recording a high quality image at high speed.

### BRIEF DESCRIPTION OF THE DRAWINGS

The invention will be described with reference to the accompanying drawings, wherein like numbers reference like elements.

FIG. 1 is a schematic diagram of an example of an ink jet recording apparatus.

FIG. 2 is a schematic diagram of an example of a discharging unit of the ink jet recording apparatus.

### DESCRIPTION OF EXEMPLARY EMBODIMENTS

Hereinafter, the preferred embodiments of the invention will be described in detail.

### Ink Jet Recording Apparatus (ink Jet Recording Method)

The preferred embodiments of the ink jet recording apparatus (the droplet ejecting apparatus) will be described below.

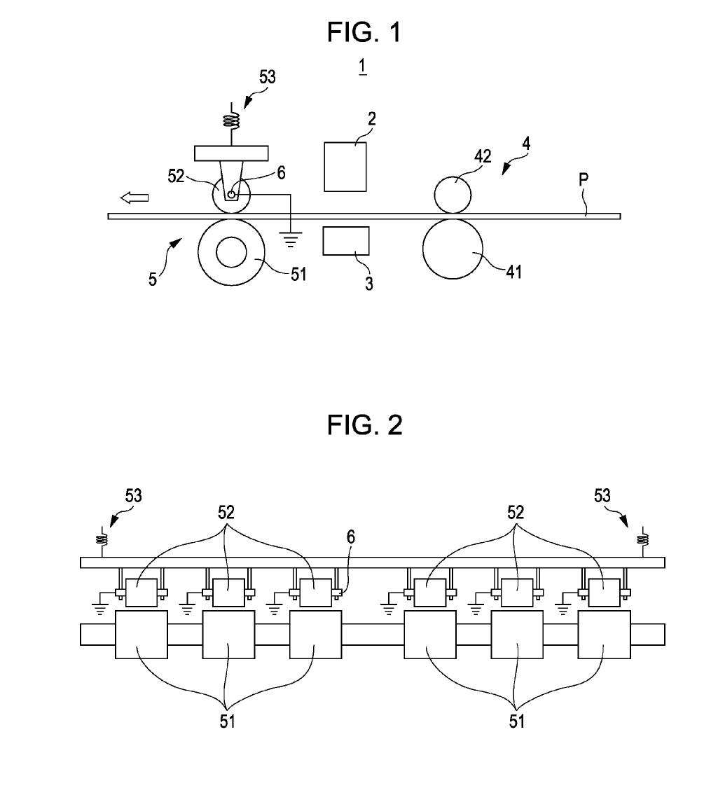

FIG. 1 is a schematic diagram of an example of an ink jet recording apparatus according to the embodiments.

As shown in FIG. 1, the ink jet recording apparatus 1 (hereinafter, referred to as printer 1) as a recording apparatus includes an ink jet head 2, a platen 3 which is grounded so as to face the ink jet head 2, a recording medium transporting unit 4 which transports the recording medium P to the ink jet head 2, and a recording medium discharging unit 5 which discharges the recording medium P on which the image is recorded. Here, grounded means that the electrical potential is equalized to the ground.

The ink jet head 2 has a function to eject the pigment ink described later and a function to record the image (data) on the recording medium P.

As an ejecting method, a thermal jet (Bubble Jet (registered trademark)) method may be used. Also, all the well-known methods of the related art may be used.

The platen 3 has a function to support the recording medium P when the pigment ink is ejected from the ink jet head 2 to the recording medium P.

The recording medium transporting unit 4, as shown in FIG. 1, is installed on the upper side than the ink jet head 2 in the transport direction of the recording medium P, and has a function to transport the recording medium P between the ink jet head 2 and the platen 3.

The recording medium transporting unit 4, as shown in FIG. 1, includes a driving roller 41 and a pressing roller 42 that is installed so as to face the driving roller 41 with the recording medium P in between. By pressing the recording medium P using the pressing roller 42, frictional force is generated between the driving roller 41 and the recording medium P, and the recording medium P is transported between the ink jet head 2 and the platen 3 by this frictional force and the driving of the driving roller 41.

The recording medium discharging unit 5 has a function to discharge the recording medium P on which the image is recorded out of the apparatus.

The recording medium discharging unit 5, as shown in FIG. 1 and FIG. 2, includes a discharging roller 51 which is installed on the opposite side to the recording surface of the recording medium P, a driven roller 52 which is installed on the recording surface side of the recording medium P so as to face the discharging roller 51, and a biasing unit 53 which biases the driven roller 52 toward the discharging roller 51.

The discharging roller 51 is configured to drive rotationally by a power (not shown) and has a function to discharge the recording medium P out of the apparatus by the frictional force with the recording medium P.

The driven roller 52 is a cylinder-shaped member, with the side of the cylinder touching the recording medium P, and is arranged to face the discharging roller 51 so that the recording medium P is placed therebetween.

However, there has been an issue that with such a cylinder-shaped driven roller, wet ink attaches to the driven roller due to the frictional electrification between the recording medium and the driven roller. The ink which has attached to the driven roller attaches to the region where the ink of the recording medium is not supposed to attach, and the quality of the image formed is deteriorated.

In order to solve such an issue, by using a spur as the driven roller, an attempt to reduce the contact area between the recording medium and the driven roller has been attempted. However, with a recent trend toward further improvement of the image recording speed, with the spur of the related art, it is difficult to deliver the driving force of the discharging roller to the recording medium and to improve the image recording speed due to the small contact area with the recording medium.

Therefore, inventors of the invention, after intensive research, discovered that the issue may be solved by making an electrical resistivity of the driven roller smaller than 10⁸ Ωcm using the cylinder-shaped driven roller, by grounding the driven roller, and by using a pigment ink with an electrical conductivity of equal to or more than 0.5 mS/m, and completed the invention. That is, the ink jet recording apparatus and the ink jet recording method according to the invention has features such that a driven roller of cylindrical shape with an electrical resistivity smaller than 10⁸ Ωcm is used, the driven roller is grounded, and a pigment ink with an electrical conductivity of equal to or more than 0.5 mS/m is used. Through these features, the generation of static electricity between the driven roller and the recording medium may be prevented. Even when static electricity is generated, for example, attachment of the pigment ink to the driven roller by electrostatic force may be prevented by using the pigment ink with high conductivity. Also, by grounding the driven roller along with composing the driven roller of materials with high conductivity, even when static electricity is generated, for example, static electricity may be released through the grounded driven roller. As a result, attachment of the pigment ink on the driven roller driven by electrostatic force may be prevented, and it is possible to increase the speed of the image recording and record a high quality image.

According to an aspect of the invention, electrical resistivity of the driven roller is smaller than 10⁸ Ωcm, however, more preferably equal to or more than 10² Ωcm and equal to or less than 10⁸ Ωcm. This may prevent the attachment of the pigment ink on the driven roller by electrostatic force more effectively.

As a material that consists the driven roller 52, while not particularly limited as long as it has conductivity, it is preferable that conductive urethane resin in which carbon is kneaded into be used. This may prevent the pigment ink on the recording medium P from attaching to the driven roller 52 more effectively, therefore, an image with higher quality may be recorded.

The driven roller 52 such as this is able to rotate on a rotating shaft (axis of rotation) 6 as the axis. Additionally, the driven roller 52 is grounded through the rotating shaft 6. The driven roller 52 and the rotating shaft 6 are connected so as to maintain conduction and, for example, are bonded with conductive adhesives publicly known.

The biasing unit 53 has a function to bias the driven roller 52 to the discharging roller 51. By biasing the driven roller 52 to the discharging roller 51, frictional force is generated between the discharging roller 51 and the recording medium P, and the recording medium P is discharged out of the apparatus by this frictional force and the driving of the discharging roller 51.

In the description above, the driven roller 52 is described as being grounded, however, the discharging roller 51 may also be grounded. Through using such a configuration, involuntarily (unintentionally) generated static electricity may be more easily released.

### Pigment ink

The pigment ink used in the invention will be described below.

For the pigment ink used in the invention, the electrical conductivity is equal to or more than 0.5 mS/m, however, it is more preferable that the electrical conductivity be equal to or more than 0.5 mS/m and equal to or less than 1.5 mS/m. This may prevent the attachment of the pigment ink to the driven roller, driven by electrostatic force, more effectively.

The composition of the pigment ink is that a pigment is dispersed in a dispersion medium and is not particularly limited as long as the electrical conductivity falls within the range described above, and, for example, may contain the following ingredients.

### Pigment

The pigment ink in the embodiments may contain a pigment as a colorant.

The pigment (pigment particle) usable in the embodiments is not particularly limited and various types of pigment publicly known may be used.

As a yellow pigment, C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, 180 and the like may be used.

As a magenta pigment, C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, 245, or C.I. Pigment Violet 19, 23, 32, 33, 36, 38, 43, 50 and the like may be used.

As a cyan pigment, C.I. Pigment Blue 1, 2, 3, 15, 15:1, 15:2, 15:3, 15:4, 15:6, 15:34, 16, 18, 22, 25, 60, 65, 66, C.I. Vat Blue 4, 60 and the like may be used.

In addition, as an organic pigment other than the magenta, the cyan, and the yellow, for example, C.I. Pigment Green 7, 10, C.I. Pigment Brown 3, 5, 25, 26, C.I. Pigment Orange 2, 5, 7, 13, 14, 15, 16, 24, 34, 36, 38, 40, 43, 63 and the like may be used.

As a black pigment, C.I. Pigment Black 1, 7, and the like may be used.

For these pigments, it is desirable that the dispersibility giving group (at least one of the hydrophilic functional groups and the salts thereof) be bonded, either directly or indirectly through an alkyl group, an alkylether group, an aryl group and the like, on the pigment surface so that these pigments are processed as self-dispersing pigments dispersed or dissolved in an aqueous medium without a dispersing agent and mixed into the pigment ink, or these pigments be mixed into the pigment ink as a pigment dispersed liquid where the pigments are dispersed into an aqueous medium. As an example of the dispersing agent, styrene-acrylic acid copolymer resin may be used. It is preferable that a dispersing agent with the molecular weight of equal to or more than 10,000 and equal to or less than 150,000 be used from a point of view that it stably disperses the pigment.

As a commercially available self-dispersing pigment in black color, for example, two different types of products from Cabot Corporation are available. They are CAB-O-JET200 (sulfonated carbon black), CAB-O-JET300 (carboxylated carbon black) (hereinbefore, product names, all made by Cabot Corporation), Bonjet Black CW-1 (product name, made by ORIENT CHEMICAL INDUSTRIES CO., LTD.), and the like.

In addition, it is preferable that these pigments have the average particle diameter in the range of equal to or more than 50 nm and equal to or less than 250 nm in order to have a good storage stability of the ink and effectively prevent clogging of the nozzle. Here, in this specification, the average particle diameter means a sphere equivalent 50% average particle diameter (d50) by dynamic light scattering and the value is obtained as follows.

Light is irradiated to the particles in the dispersion medium and the diffraction scattering light generated is measured using detectors placed at the front, side, and rear of the dispersion medium. Using the measured value obtained, what is originally an amorphous particle is assumed to be spherical, a cumulative curve is obtained with the total volume of the group of particles that are converted to spheres with the same volume as that of the particles, to be 100%, and the point at which the cumulative value becomes 50% is called “the sphere equivalent 50% average particle diameter (d50) by dynamic light scattering”. As the measuring device of the diffraction scattering light, for example, a laser diffraction scattering particle size distribution measuring device LMS-2000e (product name, manufactured by SEISHIN ENTERPRISE CO., Ltd.) and the like, may be used.

In addition, it is preferable that these pigments be contained in the range of equal to or more than 2% by mass and equal to or less than 15% by mass with respect to the total mass (100% by mass) of the pigment ink in the embodiments. If the content is equal to or more than 2% by mass, the print density is sufficient, and therefore, the color development is excellent. Also, if the content is equal to or less than 15% by mass, the nozzle does not become clogged; therefore, the ejection stability is excellent.

### Water

The pigment ink in the embodiments may contain water as a dispersion medium of the pigment. In the embodiments, water is the main solvent and it is preferable that pure water or ultra-pure water such as ion-exchanged water, ultrafiltrated water, reverse osmosis water, and distilled water be used. Particularly, it is preferable that the water be sterilized through ultraviolet light irradiation or hydrogen peroxide addition since this allows long-term storage of the pigment ink by preventing the generation of mold or bacteria.

### Ionic Substance

The pigment ink in the embodiments may contain an ionic substance. Containing the ionic substance allows the improvement of electrical conductivity of the pigment ink. As a result, attachment of the pigment ink on the recording medium to the driven roller may be prevented more effectively; therefore, an image with higher quality may be recorded.

The ionic substance, while not particularly limited, may, for example, include an alkali hydroxide such as lithium hydroxide, potassium hydroxide, sodium hydroxide and the like; an alkanolamine such as ammonia, triethanolamine, tripropanolamine, diethanolamine, and monoethanolamine.

Also, as the ionic substance, an ionic surfactant may be used. As the ionic surfactant, for example, Polity A-530, Polity A-540, Polity A-550, Polity N-100K and the like, (hereinbefore, product names, all made by Lion Corporation), Poise 521, Poise 530 and the like (hereinbefore, product names, all made by Kao Corporation) may be used.

The content of the ionic substance is preferably equal to or more than 0.01% by mass and equal to or less than 1% by mass, and is more preferably equal to or more than 0.03% by mass and equal to or less than 0.5% by mass.

### Wax

The pigment ink in the embodiments may contain a wax. Including the wax makes it difficult for the pigment ink to attach to the driven roller 52 and an image with higher quality may be recorded.

As the wax, while not particularly limited, it is preferable that a crystalline ethylene based polymer be used. This may more effectively prevent the pigment ink on the recording medium from attaching to the driven roller; therefore, an image with higher quality may be recorded.

In the embodiments, the crystalline ethylene based polymer is either an ethylene homopolymer or an ethylene/α-olefin copolymer.

As an α-olefin, propene with 3 carbon atoms, 1-butene with 4 carbon atoms, 1-pentene with 5 carbon atoms, 1-hexene and 4-methyl-1-pentene with 6 carbon atoms, 1-octene with 8 carbon atoms and the like may be used. Among these, propene, 1-butene, 1-hexene, and 4-methyl-1-pentene are more preferable.

For the crystalline ethylene based polymer, the number average molecular weight (Mn) measured by gel permeation chromatography (GPC) is preferably in the range of equal to or more than 400 and equal to or less than 8,000, more preferably in the range of equal to or more than 1,000 and equal to or less than 8,000, and even more preferably in the range of equal to or more than 2,000 and equal to or less than 5,000.

For the crystalline ethylene based polymer, Mw/Mn is preferably equal to or less than 3, more preferably equal to or less than 2.9, and even preferably equal to or less than 2.8.

For the crystalline ethylene based polymer, the relationship between the crystallization temperature (Tc(° C.), cooling rate 2° C./minute) measured by differential scanning calorimetry (DSC) and the density (D(kg/m³))measured by the density gradient tube method preferably satisfies the following formula (1) 0.501×D−366≧Tc, more preferably satisfies 0.501×D−366.5≧Tc, and even more preferably satisfies 0.501×D−367≧Tc.

The content of the wax is preferably equal to or more than 0.1% by mass and equal to or less than 5% by mass, and more preferably equal to or more than 0.2% by mass and equal to or less than 4% by mass.

### Acetylene Glycol

The pigment ink may contain acetylene glycol. Acetylene glycol is a non-ionic surfactant of symmetric structure with an acetylene group at the center, and is being applied to various water-based materials as a damping agent for which is foaming is difficult. Acetylene glycol is excellent in features such as damping, defoaming, and dispersing. Acetylene glycol is a very stable glycol in terms of its molecular structure, has a low molecular weight and has an effect of lowering the surface tension of water; therefore, is possible to adequately control the permeation of the ink into the recording medium and the bleeding of the ink on the recording medium.

As specific examples of acetylene glycol, 2,4,7,9-tetramethyl-5-decyne-4,7-diol, 3,6-dimethyl-4-octyne-3,6-diol, 3,5-dimethyl-1-hexyne-3-ol and the like may be used.

As commercially available products of acetylene glycol, for example, Surfynol 104 (series), 420, 440, 465, 485 (hereinbefore, product names, all by Air Products and Chemicals, Inc), Olfine STG, PD-001, SPC, E1004, E1010 (hereinbefore, product names, all made by Nissin Chemical Industry Co., Ltd.), Acetylenol E00, E40, E100, LH (hereinbefore, product names, all made by Kawaken Fine Chemicals Co., Ltd.) and the like may be used.

Acetylene glycol may be used either alone or as a combination of two or more.

The content of acetylene glycol is preferably equal to or more than 0.1% by mass and equal to or less than 3.0% by mass, and more preferably equal to or more than 0.3% by mass and equal to or less than 2.0% by mass.

### Unsaturated Fatty Acid

The pigment ink may contain an unsaturated fatty acid as a pH adjusting agent. Also the unsaturated fatty acid functions as an ionic substance.

Among the unsaturated fatty acid, an unsaturated fatty acid with one double bond is preferred. As a monounsaturated fatty acid, crotonic acid, myristoleic acid, palmitoleic acid, oleic acid, elaidic acid, vaccenic acid, gadoleic acid, eicosanoic acid, erucic acid, and nervonic acid and the like may be used. If there are equal to or more than two double bonds, methylene hydrogens between the two double bonds are removed and are easily oxidized. Linoleic acid and linolenic acid are such examples. An unsaturated fatty acid with one double bond, since there is no methylene hydrogen, is difficult to oxidize, therefore, has an advantage.

In addition, the pigment ink is preferably a liquid. Also, many of the saturated fatty acids which are stable against oxidation are solid at room temperature; therefore, are not suitable for addition to the ink. Oleic acid satisfies all such properties, therefore, is preferably used as the unsaturated fatty acid.

A purified unsaturated fatty acid or a vegetable oil such as olive oil of which the main ingredient is oleic acid may be used.

The unsaturated fatty acid may be used either alone or as a combination of two or more.

The content of unsaturated fatty acid is preferably equal to or more than 0.05% by mass and equal to or less than 3% by mass, and more preferably equal to or more than 0.1% by mass and equal to or less than 1% by mass.

### Wetting Agent

The pigment ink may contain a wetting agent, which prevents clogging near the nozzle of the ink jet head effectively.

As the wetting agent, for example, polyhydric alcohols such as glycerin, 1,2,6-hexanetriol, trimethylol propane, pentamethylene glycol, trimethylene glycol, ethylene glycol, propylene glycol, diethylene glycol, triethylene glycol, tetraethylene glycol, pentamethylene glycol polyethylene glycol with a number average molecular weight of equal to or less than 2,000, dipropylene glycol, tripropylene glycol, isobutylene glycol, 2-butene-1,4-diol, 2-ethyl-1,3-hexanediol, 2-methyl-2,4-pentanediol, meso-erythritol, and pentaerythritol; so-called solid wetting agents such as sugars such as glucose, mannose, fructose, ribose, xylose, arabinose, galactose, aldonic acid, glucitol (sorbitol), maltose, cellobiose, lactose, sucrose, trehalose, and maltotriose, sugar alcohols, hyaluronic acids, and ureas; alkyl alcohols having 1 to 4 carbon atoms such as ethanol, methanol, butanol, propanol, and isopropanol; and 2-pyrrolidone, N-methyl-2-pyrrolidone, 1,3-dimethyl-2-imidazolidinone, formamide, acetamide, dimethyl sulfoxide, sorbitol, sorbitan, acetin, diacetin, triacetin, and sulfolane and the like may be used.

The wetting agent may be used either alone or as a combination of two or more.

The content of the wetting agent is preferably equal to or more than 10% by mass and equal to or less than 50% by mass over the total mass (100% by mass) of the pigment ink.

### Antioxidant

The pigment ink may contain an antioxidant.

As the antioxidants (ultraviolet light absorbent), for example, allophanates such as allophanate and methyl allophanate; a biuret type such as biuret, dimethyl biuret, and tetramethyl biuret; L-ascorbic acid and salts thereof, and lanthanide oxides and the like may be used. As commercially available products of the antioxidant, for example, Tinuvin 328, 900, 1130, 384, 292, 123, 144, 622, 770, 292, Irgacor 252, 153, Irganox 1010, 1076, 1035, MD1024, and the like, made by Ciba-Geigy Ltd., may be used.

The antioxidant may be used either alone or as a combination of two or more.

The content of the antioxidant is preferably equal to or less than 0.5% by mass.

### Preservative/Ungicide

The pigment ink may contain a preservative fungicide.

As the preservative fungicide, for example, sodium benzoate, sodium pentachlorophenol, 2-pyridinethiol-1-sodium oxide, sodium sorbate, sodium dehydroacetic acid, 1,2-benzisothiazoline-3-one, dichlorophene, hexachlorophene, p-hydroxybenzoate ester, ethylenediaminetetraacetic acid (EDTA), 3,4-isothiazolin-3-one, and 4,4-dimethyloxazolidine may be used. As commercially available products of the preservative fungicide, for example, Proxel CRL, Proxel BDN, Proxel GXL, Proxel XL-2 (1,2-benzisothiazolin-3-one), Proxel TN (product names, all made by Avecia) and the like may be used.

The preservative fungicide may be used either alone or as a combination of two or more.

The content of the preservative fungicide is preferably equal to or less than 0.5% by mass.

### Permeation Enhancer

The pigment ink may contain a permeation enhancer.

As the permeation enhancer, at least one of alkyl ether of poly alcohols (also known as glycol ethers) and 1,2-alkyldiols is preferably used. As an alkyl ether of poly alcohol, for example, ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, ethylene glycol monopropyl ether, ethylene glycol mono-isopropyl ether, diethylene glycol mono-isopropyl ether, ethylene glycol monobutyl ether, diethylene glycol monobutyl ether, triethylene glycol monobutyl ether, ethylene glycol mono-t-butyl ether, diethylene glycol mono-t-butyl ether, 1-methyl-1-methoxy butanol, propylene glycol monomethyl ether, propylene glycol monoethyl ether, propylene glycol mono-t-butyl ether, propylene glycol monopropyl ether, propylene glycol mono-isopropyl ether, dipropylene glycol monomethyl ether, dipropylene glycol monoethyl ether, dipropylene glycol monopropyl ether, dipropylene glycol mono-isopropyl ether, propylene glycol monobutyl ether, dipropylene glycol monobutyl ether and the like may be used. As a 1,2-alkyldiol, for example, 1,2-pentanediol, 1,2-hexanediol and the like may be used. In addition to these, diols of straight chain hydrocarbons such as 1,3-propanediol, 1,4-butanediol, 1,5-pentanediol, 1,6-hexanediol, 1,7-heptanediol, and 1,8-octane diol may be used.

The permeation enhancer may be used either alone or as a combination of two or more.

The content of the permeation enhancer is preferably 3 to 20% by mass.

So far, the invention has been described with reference to preferred embodiments, however, the invention is not limited to these embodiments.

### EXAMPLES

Hereinafter, the invention will be described with reference to specific examples.

### 1. Pigment Ink

Pigment inks 1 to 11, of which compositions are shown in Table 1, were made by usual method and were prepared.

Also, in Table 1, a black self-dispersing pigment (made by ORIENT CHEMICAL INDUSTRIES CO., LTD., product name “Micro Jet CW1”) was presented as B, a yellow self-dispersing pigment (made by Cabot Corporation, product name “CAB-O-JET270Y”) as Y, a magenta self-dispersing pigment (made by Cabot Corporation, product name “CAB-O-JET260M”) as M, and a cyan self-dispersing pigment (made by Cabot Corporation, product name “CAB-O-JET250C”) as C, Poise 530 (made by Kao Corporation) as an ionic substance A, tripropanolamine as an ionic substance B, potassium hydroxide as an ionic substance C, oleic acid (made by Tokyo Chemical Industry Co., Ltd., monounsaturated fatty acid) as an ionic compound D, crystalline ethylene based polymer emulsion (particle size d: 200 nm, Tc: 81° C., density: 0.9 g/cm³) as a wax, Olfine E1010 (made by Nissin Chemical Industry, Co., Ltd.) as acetylene glycol, 1,2-hexanediol as a permeation enhancer A, triethylene glycol monobutyl ether as a permeation enhancer B, glycerin as a wetting agent A, trimethylolpropane as a wetting agent B, disodium ethylenediaminetetraacetate (EDTA) as a preservative•fungicide A, and Proxel XL-2 as a preservative•fungicide B.

TABLE 1

| | | | | | | | | | Permeation | |
|---|---|---|---|---|---|---|---|---|---|---|
| | | | Ionic substance | | | | | Acetylene | enhancer | |
| | Pigment | | A | B | C | D | Wax | Glycol | A | B |
| | | Content | Content | Content | Content | Content | Content | Content | Content | Content |
| | | [% by | [% by | [% by | [% by | [% by | [% by | [% by | [% by | [% by |
| | type | mass] | mass] | mass] | mass] | mass] | mass] | mass] | mass] | mass] |
| Ink 1 | B | 6.0 | — | 0.2 | 0.1 | 0.2 | — | 0.3 | 3.0 | 2.0 |
| ink 2 | Y | 6.0 | — | 0.2 | 0.1 | 0.2 | — | 0.3 | 3.0 | 2.0 |
| ink 3 | M | 6.0 | — | 0.2 | 0.1 | 0.2 | — | 0.3 | 3.0 | 2.0 |
| ink 4 | C | 6.0 | — | 0.2 | 0.1 | 0.2 | — | 0.3 | 3.0 | 2.0 |
| ink 5 | — | — | 0.5 | — | — | — | — | — | 3.0 | 2.0 |
| ink 6 | B | 6.0 | 0.3 | — | — | — | — | — | 3.0 | 2.0 |
| ink 7 | — | — | 0.1 | — | — | — | — | — | 3.0 | 2.0 |
| ink 8 | B | 6.0 | — | 0.2 | 0.1 | 0.2 | — | 0.3 | 3.0 | 2.0 |
| ink 9 | B | 6.0 | — | — | 0.1 | — | — | 0.3 | 3.0 | 2.0 |
| ink 10 | B | 6.0 | — | 0.2 | 0.1 | 0.2 | 2.0 | 0.3 | 3.0 | 2.0 |
| ink 11 | B | 6.0 | — | — | — | — | — | 0.3 | 3.0 | 2.0 |

| | Wetting agent | | Preservative•fungicide | | | |
|---|---|---|---|---|---|---|
| | A | B | A | B | Water | |
| | Content | Content | Content | Content | Content | Electrical |
| | [% by | [% by | [% by | [% by | [% by | Conductivity |
| | mass] | mass] | mass] | mass] | mass] | [mS/m] |
| Ink 1 | 10.0 | 2.0 | 0.02 | 0.3 | Residual | 1.5 |
| | | | | | quantity | |
| ink 2 | 10.0 | 2.0 | 0.02 | 0.3 | Residual | 1.5 |
| | | | | | quantity | |
| ink 3 | 10.0 | 2.0 | 0.02 | 0.3 | Residual | 1.5 |
| | | | | | quantity | |
| ink 4 | 10.0 | 2.0 | 0.02 | 0.3 | Residual | 1.5 |
| | | | | | quantity | |
| ink 5 | 10.0 | 2.0 | 0.02 | 0.3 | Residual | 1.5 |
| | | | | | quantity | |
| ink 6 | 10.0 | 2.0 | 0.02 | 0.3 | Residual | 1.1 |
| | | | | | quantity | |
| ink 7 | 10.0 | 2.0 | 0.02 | 0.3 | Residual | 0.5 |
| | | | | | quantity | |
| ink 8 | 10.0 | 2.0 | 0.02 | 0.3 | Residual | 0.8 |
| | | | | | quantity | |
| ink 9 | 10.0 | 2.0 | 0.02 | 0.3 | Residual | 0.5 |
| | | | | | quantity | |
| ink 10 | 10.0 | 2.0 | 0.02 | 0.3 | Residual | 0.8 |
| | | | | | quantity | |
| ink 11 | 10.0 | 2.0 | 0.02 | 0.3 | Residual | 0.4 |
| | | | | | quantity | |

2. Image Recording

### Example 1

In the ink jet recording apparatus shown in FIG. 1, Pigment ink 1 was set. As a material of the driven roller, a conductive urethane resin with an electrical resistivity of 1×10² Ωcm was used.

Then, a solid printing was carried out on a plain paper as the recording medium.

### EXAMPLES 2 TO 13, COMPARATIVE EXAMPLES 1 TO 3

Using the pigment inks shown in Table 2, the solid printing was carried out in the same manner as that of Example 1 except for the materials of the driven roller, which was set as shown in Table 2. Furthermore, regarding Comparative example 3, the driven roller was not grounded.

TABLE 2

| | | Driven Roller | | | Evaluation | | |
|---|---|---|---|---|---|---|---|
| | | | Electrical | | Evaluation on the | Evaluation on the | Evaluation on the |
| | Type | | Resistivity | | mark of the driven | mark of the driven | rubbing mark of the |
| | of Ink | Material | [Ωcm] | Grounding | roller 1 | roller 2 | driven roller |
| Example 1 | 1 | Conductive Urethane Resin | 1 × 10² | Yes | A | A | A |
| Example 2 | 2 | Conductive Urethane Resin | 1 × 10² | Yes | A | A | A |
| Example 3 | 3 | Conductive Urethane Resin | 1 × 10² | Yes | A | A | A |
| Example 4 | 4 | Conductive Urethane Resin | 1 × 10² | Yes | A | A | A |
| Example 5 | 1 | Conductive Urethane Resin | 2 × 10⁴ | Yes | A | A | A |
| Example 6 | 1 | Conductive Urethane Resin | 9 × 10⁶ | Yes | A | A | A |
| Example 7 | 1 | Conductive Urethane Resin | 3 × 10⁸ | Yes | A | A | B |
| Example 8 | 5 | Conductive Urethane Resin | 3 × 10⁸ | Yes | A | A | B |
| Example 9 | 6 | Conductive Urethane Resin | 3 × 10⁸ | Yes | A | A | B |
| Example 10 | 7 | Conductive Urethane Resin | 3 × 10⁸ | Yes | A | B | B |
| Example 11 | 8 | Conductive Urethane Resin | 3 × 10⁸ | Yes | B | B | B |
| Example 12 | 9 | Conductive Urethane Resin | 3 × 10⁸ | Yes | B | B | B |
| Example 13 | 10 | Conductive Urethane Resin | 1 × 10² | Yes | A | A | A |
| Comparative | 11 | Conductive Urethane Resin | 1 × 10² | Yes | B | C | B |
| example 1 | | | | | | | |
| Comparative | 1 | Non-conductive Urethane | 3 × 10⁹ | Yes | C | C | B |
| example 2 | | Resin | | | | | |
| Comparative | 9 | Conductive Urethane Resin | 3 × 10⁸ | No | B | B | C |
| example 3 | | | | | | | |

### 3. Evaluation

### Evaluation on Mark of Driven Roller 1

For the recorded materials from each example and comparative example, both the OD value of the portion that the driven roller passed through and the OD value of the rest of the portion were measured using a Gretag densitometer (manufactured by GretagMacbeth). The difference between the OD values was measured and was evaluated according to the following criteria.
A: The difference is equal to or more than 0 and less than 0.007 (acceptable).
B: The difference is equal to or more than 0.007 and less than 0.017 (acceptable).
C: The difference is equal to or more than 0.017 (not acceptable).

### Evaluation on Mark of Driven Roller 2

For the recorded materials from each example and comparative example, a visual evaluation as to whether there was a mark of ink attached on the driven roller was carried out and was evaluated according to the following criteria. Five people participated in the evaluation and the grading given by the majority was chosen.
A: The mark is not identifiable from the 20 cm position.
B: The mark is not identifiable from the 50 cm position (acceptable).
C: The mark is identifiable from the 50 cm position (not acceptable).

### Evaluation on Rubbing Mark of Driven Roller

For the recorded materials from each example and comparative example, a visual inspection as to whether there was a rubbing mark on the driven roller was carried out and was evaluated according to the following criteria. Five people participated in the evaluation and the grading given by the majority was chosen.
A: There is no mark.
B: There is a faint mark but acceptable.
C: There is a clear mark (not acceptable).

These results are summarized in Table 2.

As is apparent from Table 2, it was possible to record high quality images according to the invention. Also, according to the invention, since the driven roller is not a spur, it was possible to record at high speed. In contrast, in the comparative examples, satisfactory results were not able to be obtained.

What is claimed is:

1. An ink jet recording apparatus in which an image is recorded by ejecting a pigment ink from an ink jet head on a recording surface of a recording medium, the apparatus comprising:
a recording medium transporting unit which transports the recording medium, and
a recording medium discharging unit which discharges the recording medium,
wherein the recording medium discharging unit includes a discharging roller installed on the opposite side to the recording surface of the recording medium and a cylinder-shaped driven roller installed on the recording surface side of the recording medium so as to face the discharging roller,
the driven roller has an electrical resistivity smaller than 10⁸ Ωcm, and is grounded, and
the pigment ink has an electrical conductivity of equal to or more than 0.5 mS/m.

2. The ink jet recording apparatus according to claim 1,
wherein the driven roller is formed of a material that contains a conductive urethane resin.

3. The ink jet recording apparatus according to claim 1,
wherein the pigment ink contains a wax.

4. The ink jet recording apparatus according to claim 3,
wherein the wax contains a crystalline ethylene based polymer.

5. The ink jet recording apparatus according to claim 1,
wherein the pigment ink contains an ionic substance.

6. An ink jet recording method in which an image is recorded by ejecting a pigment ink from an ink jet head on a recording surface of a recording medium, the method comprising:
preparing an ink jet recording apparatus including a recording medium transporting unit which transports the recording medium to the ink jet head and a recording medium discharging unit which discharges the recording medium on which the image is recorded by the ink jet head, and
preparing, in the recording medium discharging unit, a discharging roller installed on the opposite side to the recording surface of the recording medium and a cylinder-shaped driven roller installed on the recording surface side of the recording medium so as to face the discharging roller,
wherein the driven roller has an electrical resistivity smaller than 10⁸ Ωcm, and is grounded, and
the pigment ink has an electrical conductivity of equal to or more than 0.5 mS/m.
